(19) United States
(12) Patent Application Publication
(10) Pub. No.: US 2007/0047641 A1
(43) Pub. Date: Mar. 1, 2007

(54) Self-contained security system

(76) Inventors: James Bellinson, Bloomfield Hills, MI (US); Gregory M. Campbell, Rochester Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/213,109

(22) Filed: Aug. 26, 2005

(51) Int. Cl. H04N 11/04; H04N 7/18

(52) U.S. Cl. 375/240.01; 348/155

(57) ABSTRACT

A self-contained security system captures images of a defined area with a surveillance system and communicates the images to a remote cellular device in response to pre-defined conditions. A controller, a cellular communication system, a motion detector and the surveillance system are all mounted within a housing. The self-contained security system is remotely accessible via the remote cellular device to change existing system settings and to view images recorded by the surveillance system.

### BACKGROUND OF THE INVENTION

The present invention relates to a security system, and more particularly to a remotely accessible self-contained security system.

Conventional security systems of the alarm or surveillance type are typically hard wired throughout a structure with the wiring terminating at a control panel. Although effective, these types of security systems are typically dedicated systems which utilize a landline telephone system.

Security camera systems with some functionality to capture images are known. Systems of this type typically initiate an alert to a security monitoring company in response to a detected intrusion or are continually monitored. These security camera systems may be relatively complicated and expensive to install and operate. Wireless security systems are also known. These security systems provide views of a designated area on the Internet by capturing still images in real time. Functionality of the security system is controlled through an Internet browser. Disadvantageously, the information provided by these types of security systems may be inconvenient to access due to the necessity of having a computer with Internet capability readily available to view the images captured by the security system.

Accordingly, it is desirable to provide a security system that is readily installed in a variety of locations and is remotely accessible.

### SUMMARY OF THE INVENTION

A self-contained security system according to the present invention includes a controller, a surveillance system, a motion detector and a cellular communication system.

The cellular communication system communicates images recorded by the surveillance system to a remote cellular device in response to pre-defined conditions. The self-contained security system is remotely accessible by the remote cellular device to change existing system settings such as the preferred time period for which the surveillance system captures images and to redefine a defined area for surveillance.

The self-contained security system of the present invention provides a security system that is readily installed in a variety of locations and is remotely accessible.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic representation of a possible mounting location of a self-contained security system according to the present invention;

FIG. 2 is a schematic representation of the components included within the self-contained security system according to the present invention; and

FIG. 3 is a schematic representation of the self-contained security system of the present invention in operation.

### DETAILED DESCRIPTION OF THE PREFERRED EMBODIMENT

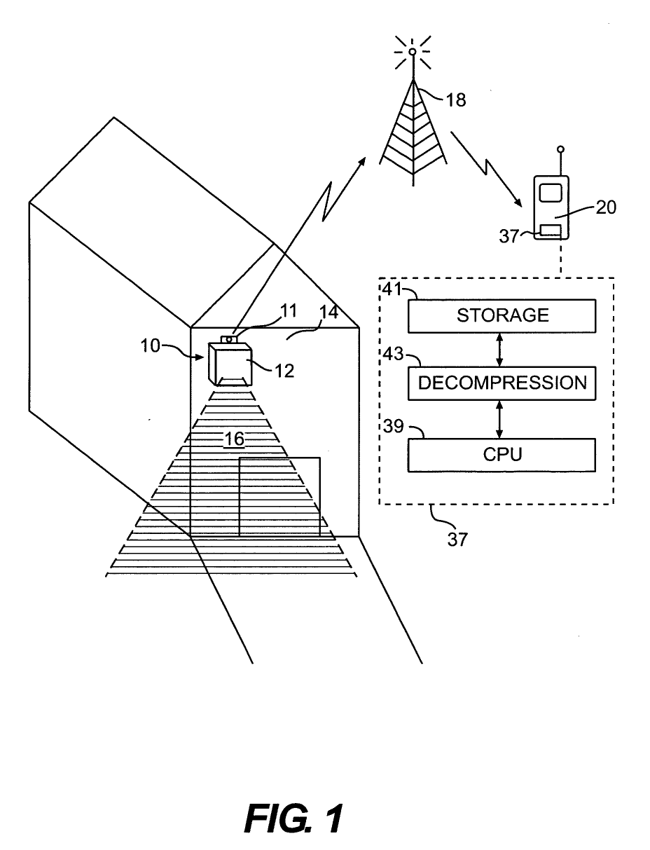

Referring to FIG. 1, a self-contained security system 10 is illustrated. The self-contained security system 10 is entirely contained within a housing 12 such that the self-contained security system 10 is readily movable to various locations. It should be understood that the housing 12 may be of various configurations. The housing 12 preferably includes a tamper-proof bracket 11 for mounting the housing 12 of the self-contained security system 10.

The housing 12 of the self-contained security system 10 is mounted to a building wall 14. It should be understood that the self-contained security system 10 according to the present invention may be mounted on any surface to surveil a defined area 16. The defined area 16 is selected by the user and may be physically redefined by relocating the housing 12 to a different location. The self-contained security system 10 is operable to communicate recorded images, including pictures and video, of the defined area 16 to a complementary transceiver 18, such as a cell tower or a satellite constellation. The complementary transceiver 18 subsequently communicates the recorded images to a remote cellular device 20 such as a cellular phone. It should be understood that other devices may be utilized as the remote cellular device 20 of the present invention.

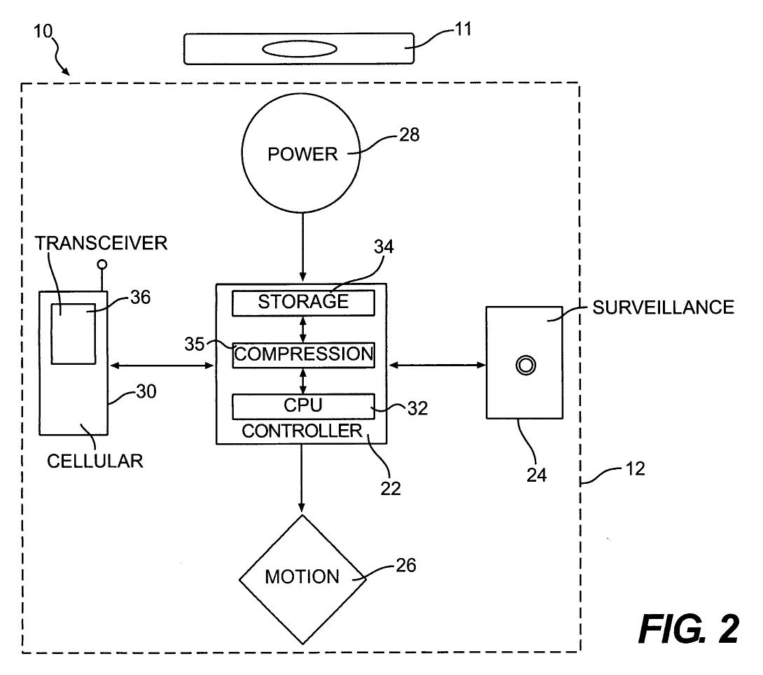

Referring to FIG. 2, the self-contained security system 10 generally includes a controller 22, a surveillance system 24, a motion detector 26, a power supply 28, and a cellular communication system 30 contained within the housing 12.

The controller 22 includes a central processing unit (CPU) 32 and a storage device 34. The storage device 34 may include a hard drive, CD ROM, DVD, RAM, ROM or other optically readable storage, magnetic storage or integrated circuit.

The controller 22 communicates with the surveillance system 24 to surveil the defined area 16 (FIG. 1). Preferably, the surveillance system 24 includes a digital camera. It should be understood that other devices such as night observation devices may also be utilized as the surveillance system 24 of the present invention. Images captured by the surveillance system 24 are preferably stored in the storage device 34.

The motion detector 26 detects motion outside of the housing 12 and communicates the detected motion to the controller 22. Preferably, the motion detector 26 is a passive infrared motion detector. However, the controller 22 may also be programmed to detect motion without a motion detector 26. A motion can be detected by comparing the percentage of difference between uncompressed frames recorded by the surveillance system 24. The surveillance system 24 is activated in the same manner as if the motion detector 26 detected motion when the percentage of difference between the uncompressed frames achieves a pre-determined sensitivity level.

The power supply 28 includes a rechargeable battery pack and is preferably recharged using solar power. Therefore, the housing 12 requires no external connections. It should be understood that other power supplies may be utilized by the present invention. Thus, the self-contained security system 10 is easily mounted in a variety of locations.

The cellular communication system 30 includes a transceiver 36, such as a cellular, PCS, satellite, RF, microwave or other wireless communication system. The transceiver 36 is connected to the CPU 32, which includes the appropriate communication software. The communication software is preferably stored in the storage device 34 as well as instructions for operation of the self-contained security system 10.

The controller 22 further includes a compression unit 35. The compression unit 35 receives the digital images recorded by the surveillance system 24 in sequence and converts the images to a compressed data stream prior to delivery of the compressed images to the remote cellular device 20. Preferably, the compression unit 35 utilizes a standard compression method such as MPEG4. It should be understood that the compression unit 35 is programmable such that any compression method may be utilized. The remote cellular device 20 (FIG. 1) includes a controller 37 having a CPU 39 and a storage device 41 similar to that of the storage device 34 of the self-contained security device 10. It should be understood that due to the computational power required to compress and decompress the video images sufficient for transfer over the cellular communication system 30, the CPU 32 and the storage device 34 may temporarily record the video images prior to transmission of the compressed video stream. The more efficient the video compression software, the shorter the delay between compression and transmission such that “real time” video is essentially provided. The controller 37 of the remote cellular device 20 also includes a decompression unit 43 programmed to decompress the compressed data stream received from the self-contained security system 10. Once decompressed, the images may be viewed on the remote cellular device 20. The images may be saved within the storage device 41 or deleted after being viewed on the remote cellular device 20.

The transceiver 36 communicates with the complementary transceiver 18 (FIG. 1). The complementary transceiver 18 is connected via telephone lines, wireless links (such as cell towers or satellites), and/or the Internet to a second location such as a remote cellular device 20 (as shown in FIG. 1). In general, information is directly exchanged between the remote cellular device 20 and the self-contained security system 10 via the transceivers 18 and 36. Details of the information exchanged will be generally described below; however, one of ordinary skill in the art with the benefit of the teachings disclosed herein will be able to implement the appropriate instructions to facilitate the exchange of information.

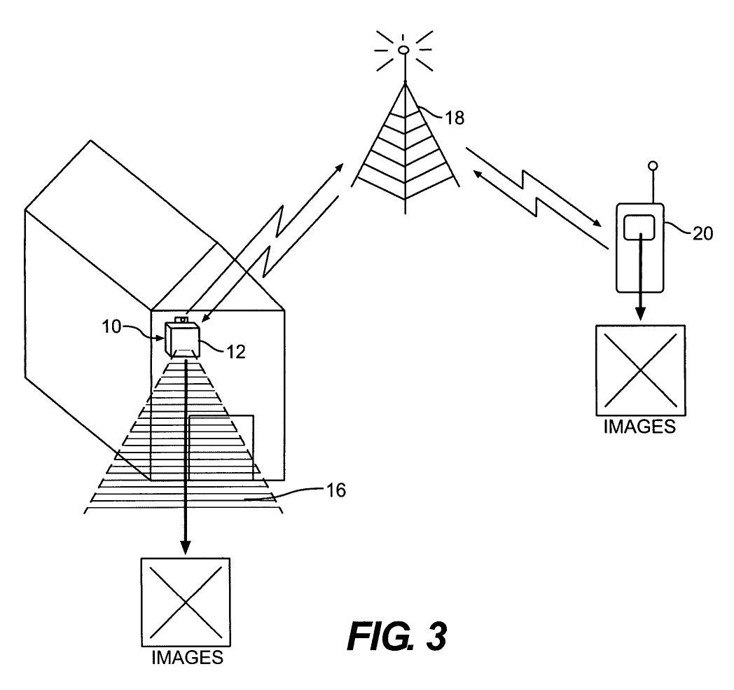

Referring to FIG. 3, operation of the self-contained security system 10 is schematically illustrated. In a standby mode, the self-contained security system 10 preferably monitors only the motion detector 26 using a limited amount of processing power. The self-contained security system 10 is brought into an active mode in response to a pre-defined event such as movement detected by the motion detector 26 (FIG. 2) or other pre-defined conditions. Once brought into the active mode, the self-contained security system 10 attempts to contact a configured number to establish a connection with the remote cellular device 20. The self-contained security system 10 preferably stores the images recorded in the storage device 34 (FIG. 2) until a connection is established with the remote cellular device 20. Therefore, there may be a further lag between the time the images are recorded by the self-contained security system 10 and the time in which a user is able to view the images at the remote cellular device 20 as discussed above.

Once the connection is established with the remote cellular device 20, the images recorded by the self-contained security system 10 of the defined area 16 are communicated to the remote cellular device 20. Preferably, the images being stored in the storage device 34 are simultaneously being compressed sufficiently to be communicated over the cellular communication system 30. That is, while the connection is being established the security system 10 is recording and compressing the imagery. The images are sent to the remote cellular device 20 in response to the pre-defined conditions. The pre-defined conditions include motion detected by the motion detector 26 and a time schedule as set by the user. The time schedule may be programmed into the controller 22 (FIG. 2) to allow the self-contained security system 10 of the present invention to send images during specific hours of the day, or to record images on specific days such as when a user knows he/she will be absent from home, etc for later transmission at a predetermined time. The pre-defined conditions may be set and redefined by the user by programming the instructions in the controller 22 through the remote cellular device 20. Once the images are communicated to the remote cellular device 20, the user may view the images to determine whether a true security breach has occurred. The self-contained security system 10 may also operate in a monitoring mode in which images of the defined area 16 are continuously recorded.

In addition to the self-contained security system 10 initiating communication with the remote cellular device 20 in response to pre-defined conditions, the remote cellular device 20 may be used to establish a connection with the self-contained security system 10. By establishing a connection, the self-contained security system is brought into the active mode. The remote cellular device 20 remotely communicates with the controller 22 (as shown in FIG. 2) of the self-contained security system 10 to alter operation thereof. The remote cellular device 20 communicates with the self-contained security system 10 in the same manner described in FIG. 2. Preferably, system settings of the self-contained security system 10 are altered through use of an automated user menu programmed into the controller 22. For instance, the automated user menu may include an option to alter the time schedule for which the self-contained security system 10 records images and redefine the defined area 16 by commanding the controller 22 to communicate with the surveillance system 24 (FIG. 2) by panning, tilting or zooming. The remote cellular device 20 may also be used to view recorded images of the defined area 16 stored in the storage device 34. It should be understood that additional options may be included within the automated user menu and programmed into controller 22.

That the foregoing description shall be interpreted as illustrative and not in a limiting sense is thus made apparent. A worker of ordinary skill in the art would recognize that certain modifications would come within the scope of this invention. For that reason, the following claims should be studied to determine the true scope and content of this invention.

What is claimed is:

1. A security system comprising:
a housing;
a controller mounted within said housing;
a surveillance system in communication with said controller; and
a cellular communication system in communication with said controller, said cellular communication system operable to communicate images captured by said surveillance system to a remote cellular device in response to a pre-defined condition.

2. The security system as recited in claim 1, further comprising a motion detector in communication with said controller.

3. The security system as recited in claim 2, wherein said pre-defined condition includes a motion detected by said motion detector.

4. The security system as recited in claim 1, wherein said pre-defined condition includes a time schedule.

5. The security system as recited in claim 4, wherein said time schedule is defined by a user.

6. The security system as recited in claim 1, further comprising a power supply mounted within said housing, wherein said power supply includes solar power.

7. The security system as recited in claim 1, wherein said controller includes a central processing unit, a storage device and a compression unit.

8. The security system as recited in claim 7, wherein said compression unit compresses said images and subsequently communicates said images to said storage device.

9. The security system as recited in claim 8, wherein said images are communicated to said storage device while said cellular communication system establishes a connection with said remote cellular device.

10. The security system as recited in claim 9, wherein said images are immediately communicated to said remote cellular device upon said connection being established.

11. The security system as recited in claim 1, wherein said cellular communication system communicates with said remote cellular device to change system settings.

12. The security system as recited in claim 1, wherein said remote cellular device includes a controller programmed to decompress said images received from said security system.

13. A method of surveillancing an area comprising:
(1) recording an image of a defined area;
(2) compressing the image into a compressed data stream;
(3) communicating with a remote cellular device; and
(4) transmitting the compressed data stream to the remote cellular device.

14. The method as recited in claim 13, further comprising the steps of:
(5) communicating with a security system with the remote cellular device; and
(6) changing system settings of the security system.

15. The method as recited in claim 13, wherein said step (1) further comprises: remotely defining a preferred time schedule for recording the image of the defined area.

16. The method as recited in claim 13, wherein said step (1) further comprises: recording the image of the defined area in response to a detected motion.

17. The method as recited in claim 13, wherein said step (2) further comprises: storing the compressed data stream into memory.

18. The method as recited in claim 17, wherein said step (2) occurs prior to establishing said step (3).

19. The method as recited in claim 13, further comprising the step of:
(7) decompressing the image data stream and viewing the image recorded of the defined area on the remote cellular device.
